(19) United States
(12) Patent Application Publication
(10) Pub. No.: US 2024/0206446 A1
(43) Pub. Date: Jun. 27, 2024

(54) FISHING REEL INCLUDING VARIABLE BRAKE DISPLACEABLE IN AXIAL DIRECTION OF SPOOL AND MAGNET DISPLACEABLE PERPENDICULARLY TO AXIAL DIRECTION OF SPOOL

(71) Applicant: DOYO ENGINEERING CO., LTD., Bucheon-city (KR)

(72) Inventor: Kang Ho HYUN, Bucheon-city (KR)

(21) Appl. No.: 18/531,249

(22) Filed: Dec. 6, 2023

(30) Foreign Application Priority Data
Dec. 21, 2022 (KR) 10-2022-0180260

(51) Int. Cl. A01K 89/033

(52) U.S. Cl. CPC A01K 89/058

(57) ABSTRACT

Provided is a fishing reel. A shaft extends therethrough the spool to be axially mounted on a reel body, and a fishing line is wound on the spool. A variable brake includes a facing portion provided in a circumferential direction of the spool, and is coupled to one end of the shaft to be movable forwards and backwards in an axial direction of the spool and is elastically supported toward the spool. Magnet holders are provided in a circumferential direction of the facing portion, coupled in a direction of an inner or outer circumferential surface of the facing portion to be movable forwards and backwards in a direction perpendicular to the axial direction of the spool, and include magnets mounted to form opposing surfaces with respect to the facing portion. A braking force control means for moving the magnet holders forwards and backwards.

### BACKGROUND

### Technical Field

The present disclosure relates to a fishing reel including a variable brake displaceable in the axial direction of a spool and magnets displaceable perpendicularly to the axial direction of the spool and, more particularly, to a fishing reel configured such that the variable brake is applied to the spool so that the distance between the variable brake and the magnets may automatically be varied due to centrifugal force depending on the rotating speed of the spool and the position of a holder holding the magnets may be dialed.

### Description of the Related Art

When a fishing reel is cast, the speed at which the spool rotates to unwind the line is generally faster than the speed at which the lure flies, which reduces the flying distance of the lure or tangles the line. This phenomenon is known as backlash.

To prevent such backlash, fishing reels generally use a friction brake using physical friction and a magnetic brake using the attraction of magnets.

In these brakes, the magnetic brake is a non-contact brake different from the friction brake. The magnetic brake uses the attraction of a plurality of magnets provided on a reel body to apply the magnetic attraction to a rotating spool, thereby slowing down the rotation of the spool.

In a magnetic brake of the related art, a ring-type plate is mounted on one side surface of a spool, and a plurality of magnets are arranged in a circle on one side spaced from the plate to face the plate. During high-speed rotation of the spool, the magnetic force of the magnets acts on the plate to generate braking force, thereby preventing backlash.

The magnetic brake of the related art described above is configured to adjust the distance between the plate and the magnets by moving a holder holding the magnets in the axial direction of the spool, thereby controlling the braking force.

However, since the magnetic brake of the related art adjusts the fine distance between the plate and the magnets facing the plate, the range in which the braking force is adjusted may necessarily be narrow. When the holder is moved farther to increase the range in which the braking force is adjusted, the size of the body of the fishing reel may increase accordingly, which is problematic.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to provide a fishing reel including a variable brake displaceable in the axial direction of a spool and magnets displaceable perpendicularly to the axial direction of the spool, the fishing reel enabling a user to use the fishing reel by adjusting braking force according to his/her own fishing style by combining the advantages of the centrifugal brake, the magnetic brake, and the inertia brake of the related art, such as ability to prevent pad wears, ability to prevent casting distance reduction and backlash in low speed rotation of the spool, and compatibility with either a left or right handed handle, and the like.

In order to achieve at least one of the above objectives, according to one aspect of the present disclosure, there is provided a fishing reel including: a spool configured such that a shaft extends therethrough to be axially mounted on a reel body and a fishing line is wound thereon; a variable brake including a facing portion provided in a circumferential direction of the spool, wherein the variable brake is coupled to one end of the shaft to be movable forwards and backwards in an axial direction of the spool and is elastically supported toward the spool; magnet holders provided in a circumferential direction of the facing portion, coupled in a direction of an inner or outer circumferential surface of the facing portion to be movable forwards and backwards in a direction perpendicular to the axial direction of the spool, and including magnets mounted to form opposing surfaces with respect to the facing portion; and a braking force control means for moving the magnet holders forwards and backwards.

In the fishing reel according to the present disclosure, the braking force control means may include: a dial cam configured to rotate in the circumferential direction of the spool at one side of each of the magnet holders and including a cam portion configured to press and move the magnet holder forwards and backwards in a direction perpendicular to the axial direction of the spool; and a control dial provided on a side cover to rotate the dial cam.

In addition, in the fishing reel according to the present disclosure, each of the magnet holder may include a protrusion protruding from one side surface thereof and configured to be pressed, and the cam portion may include a pressing groove circumferentially formed in the other side surface of the dial cam such that the protrusion configured to be pressed is fitted thereto. The cam portion may be configured to press the protrusion configured to be pressed, with a distance thereof from a center of the dial cam gradually increasing in a direction from one end to the other end thereof.

In addition, the fishing reel according to the present disclosure may further include a spool cover including: a receiving portion on one side of the magnet holders so as to receive the magnet holders; and guide recesses configured to guide the holders in a direction perpendicular to the axial direction of the spool.

According to the present disclosure, the fishing reel may include the variable brake displaceable in the axial direction of the spool and the magnets displaceable perpendicularly to the axial direction of the spool, and may enable a user to use the fishing reel by adjusting braking force according to his/her own fishing style by combining the advantages of the centrifugal brake, the magnetic brake, and the inertia brake of the related art.

### BRIEF DESCRIPTION OF THE DRAWINGS

The above and other objectives, features, and other advantages of the present disclosure will be more clearly understood from the following detailed description when taken in conjunction with the accompanying drawings, in which:

FIGS. 1 and 2 are cross-sectional views illustrating a fishing reel according to the present disclosure; and

FIGS. 3 and 4 are perspective views illustrating the fishing reel according to the present disclosure.

### DETAILED DESCRIPTION

The present disclosure may be modified in various forms, and aspects (or embodiments) will be described in detail below. However, the present disclosure is not limited to the specific embodiments disclosed and should be understood to include all modifications, equivalents, and substitutions falling within the spirit and technical scope of the present disclosure.

In the drawings, like reference numerals, particularly, reference numerals having the same last two digits or the same last one digit and letter refer to like elements having like functions throughout. Unless the context clearly indicates otherwise, elements referred to by reference numerals of the drawings should be understood according to this standard.

With respect to the components in the drawings, although the components are illustrated in an exaggerated, enlarged (thicker) or miniaturized (thinner) size or thickness or illustrated in a simplified manner for better understanding of the components, the scope protected by the present disclosure should not be construed as being limited by the manner illustrated.

Terms used herein are used to describe a specific embodiment (or aspect) and are not intended to limit the present disclosure, and singular forms are intended to include plural forms unless the context clearly indicates otherwise.

Further, herein, it should be understood that the terms “include” or “comprise” indicate that a feature, a number, a step, an operation, a component, a part or the combination thereof described in the specification is present, but does not exclude a possibility of presence or addition of one or more other features, numbers, steps, operations, components, parts or combinations thereof in advance.

Unless otherwise defined, all terms including technical and scientific terms used herein have the same meaning as commonly understood by those skilled in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The terms “first”, “second”, and the like are used herein only for the purpose of differentiating between components, and are not used to indicate the order of preparation steps. There may be inconsistencies in naming the terms between the detailed description and the claims.

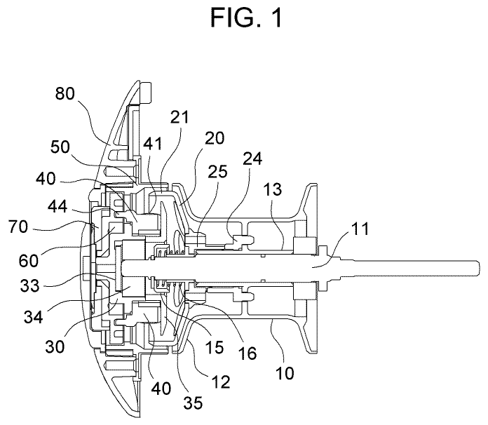

In describing the fishing reel according to the present disclosure, a non-strict orientation standard will be approximated for convenience with reference to FIG. 1 such that up, down, left, and right are determined according to the direction of view, with the direction in which gravity acts being the downward direction.

Hereinafter, a fishing reel according to the present disclosure will be described with reference to the accompanying drawings.

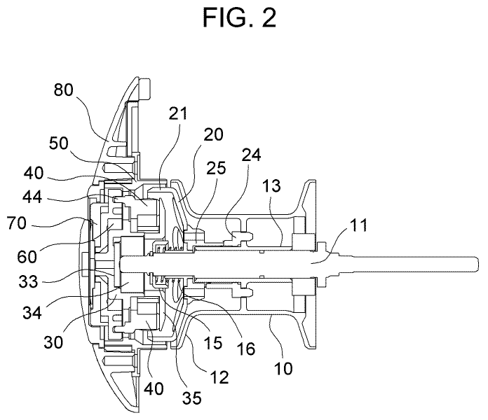

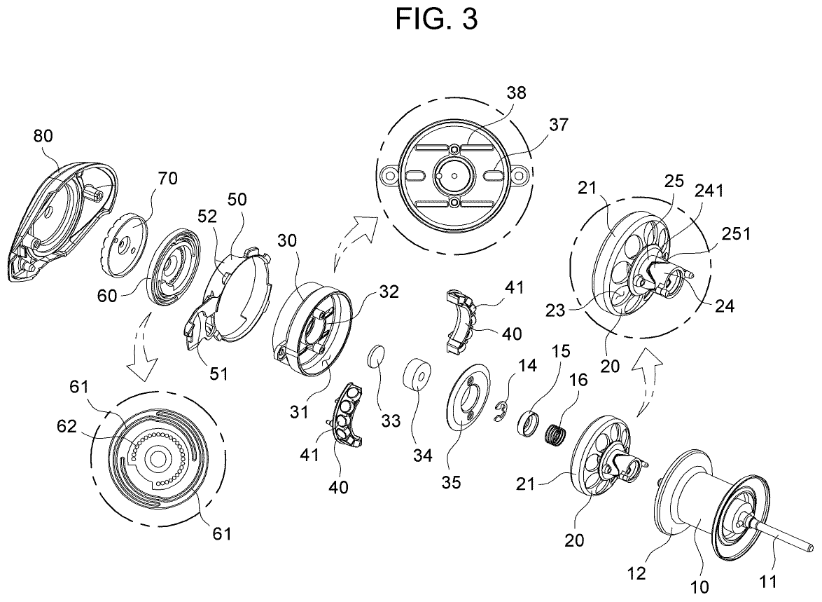

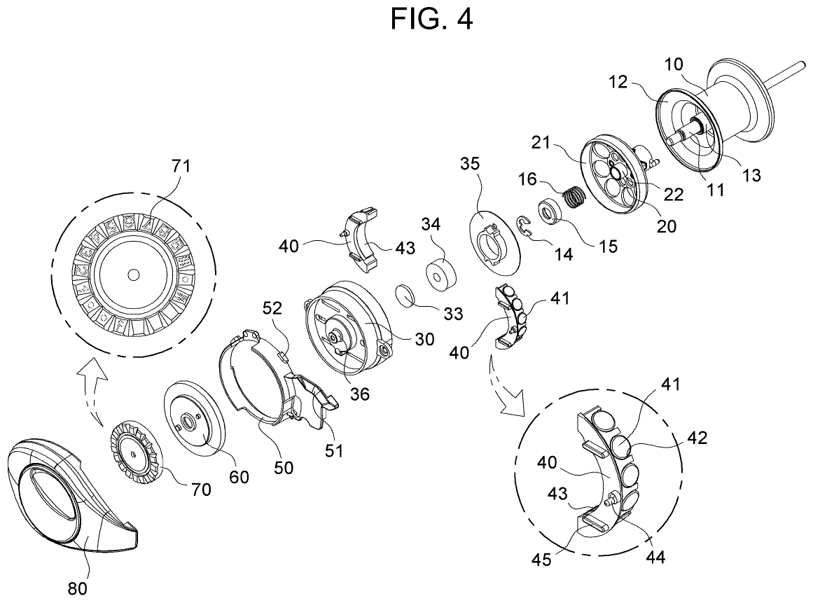

As illustrated in FIGS. 1 to 4, the fishing reel according to the present disclosure generally includes a spool 10, a variable brake 20, a spool cover 30, magnet holders 40, a rocking lever 50, a dial cam 60, a control dial 70, and a side cover 80. The dial cam 60 and the control dial 70 constitute a braking force control means.

First, the figures of the present disclosure illustrate, as an example, an embodiment in which a side cover 80 on the palm side to which the spool cover 30 is coupled is detachably coupled to one end of a frame (not shown). Here, the attachment/detachment structure of the side cover 80 on the palm side may be modified variously.

The figures illustrate an embodiment in which the rocking lever 50 disposed within the side cover 80 is configured to rotate about the outer circumferential surface of the spool cover 30. The rocking lever 50 is rotated using the handle 51, so that the locking protrusion 52 is attached to and detached from the frame as a fitting #hanging #structure.

The other basic components of the fishing reel such as the frame (not shown) are known in the art and thus will not be described for the convenience of understanding.

Specifically, the present disclosure includes:
the spool 10 configured such that the shaft 11 extends therethrough to be axially mounted on a reel body and a fishing line is wound thereon;
the variable brake 20 including a facing portion 21 provided in the circumferential direction of the spool 10, wherein the variable brake 20 is coupled to one end of the shaft 11 to be #movable forwards and backwards in the axial direction of the spool 10 and is elastically supported toward the spool 10;
the magnet holders 40 provided in the circumferential direction of the facing portion 21, coupled in the direction of the inner or outer circumferential surface of the facing portion 21 to be movable forwards and backwards in a direction perpendicular to the axial direction of the spool 10, and including magnets 41 mounted to form opposing surfaces with respect to the #facing portion 21; and
the braking force control means for moving the magnet holders 40 forwards and backwards.

In addition, the braking force control means includes:
the dial cam 60 configured to rotate in the circumferential direction of the spool 10 at one side of the magnet holders 40 and including a cam portion configured to press and move the magnet holders 40 forwards and backwards in a direction perpendicular to the axial direction of the spool 10; and
the control dial 70 provided on the side cover 80 to rotate the dial cam 60.

Here, the opposing surfaces of the magnets 41 indicate a shape in which both surfaces having a predetermined area from which a significant strength of magnetic force is generated are opposed to each other on inner and outer sides perpendicular to the axial direction of the spool 10. The figures of this specification illustrate an embodiment in which the magnet holders 40 are disposed in the direction of the inner circumferential surface of the facing portion 21 to form the opposing surfaces of the magnets 41, but the magnet holders 40 may be disposed in the direction of the outer circumferential surface of the facing portion 21 to form the opposing surfaces of the magnets 41.

In a magnet holder of the related art, magnets facing in the axial direction of the spool faces one plate of the spool, such that the magnetic force of the magnets act in the axial direction of the spool.

In contrast, according to the present disclosure, the magnetic force of the magnets 41 may act in the radial direction of the spool 10 perpendicular to the axial direction of the spool 10.

Accordingly, the variable brake 20 has the shape of a ring in which the facing portion 21 is arranged in parallel to the spool 10 in the axial direction so that the variable brake 20 faces the inner or outer opposing surfaces of the magnets 41.

In addition, the figures of this specification illustrate a deep spool in which flange portions 12 protruding from left and right sidewall portions bent from both ends of the spool 10 at angles close to the rectangular angle (e.g., about 80° to 90°) to increase the diameter, but the present disclosure is not limited thereto. (For example, the entirety of the spool 10 may be configured as a cylinder.)

Within the spool 10, a pipe-shaped shaft coupling portion 13 is provided in the axial direction such that the shaft 11 extends through and is coupled to the shaft coupling portion 13.

In addition, a support cap 15 is coupled to one end of the shaft 11 by means of a binding ring 14 such as a C-ring. As one end of a compression spring 16 is supported on the support cap 15 and the other end of the compression spring 16 is supported on the variable brake 20, the variable brake 20 is pressed in the direction of the spool 10 to move backwards.

One side surface (i.e., an outer surface) of the variable brake 20 is open due to the facing portion 21 extending in the shape of a flange. A shaft fitting portion 22 protrudes from a central portion of one side, and the shaft 11 extends through and fitted to the shaft fitting portion 22. A plurality of through-holes 23 are arranged radially in the variable brake 20 to reduce the weight of the variable brake 20.

In addition, the variable brake 20 is configured to move forwards and backwards in the axial direction of the spool 10 due to a centrifugal action in response to the rotation of the spool 10, and includes a fixed cam 24 coupled to an open area on one side of the spool 10 and a variable cam 24 coupled to the other side surface (i.e., the inner surface) of the variable brake 20.

The fixed cam 24 and the variable brake 20 are matingly coupled to each other in an engagement structure, and contact surfaces of the fixed cam 24 and the variable brake 20 have cam slope portions 241 and 251 having a predetermined degree of slope.

When the rotation of the spool 10 accelerates, the second cam slope portion 251 of the variable brake 20 coupled to the variable brake 20 is pushed in one direction (e.g., outwards) by the first cam slope portion 241 of the fixed cam 24 fixed to the spool 10 so that the variable brake 20 moves forwards to be spaced apart from the spool 10.

When the rotation of the spool 10 decelerates, variable brake 20 moves backwards and returns to the original position due to the elastic force of the compression spring 16.

Here, as the forward movement of the variable brake 20 varies depending on the centrifugal force, i.e., the speed of rotation of the spool 10, the strength of the magnetic force of the magnets 41 acting on the facing portion 21 may change, thereby appropriately controlling braking force according to the speed of rotation of the spool 10.

The spool cover 30 covers the facing portion 21 of the variable brake 20 in a position in which the spool cover 30 is coupled to the side cover 80, thereby holding the spool 10 and the variable brake 20.

The spool cover 30 has the shape of a drum compartmentalized by a central partition, with one and the other sides being open. The magnet holders 40 are fitted to a receiving portion 31 in the open area at the other side.

The spool cover 30 has a shaft fitting portion 32 protruding at the center of the receiving portion 31. As a backing member 33 and a bearing 34 are mounted on the shaft fitting portion 32, one end of the shaft 11 is fitted into and supported by the bearing 34.

In addition, the spool cover 30 further includes a fixing plate 35 coupled to the receiving portion 31, the open area on the other side, of the spool cover 30 while covering the magnet holders 40.

The fixing plate 35 allows the bearing 34 to be fitted and coupled thereto, and covers the open area on the other side of mounting recesses 42 in which the magnets 41 are fitted, thereby preventing the magnets 41 from being separated or detached from the magnet holders 40.

In addition, a shaft protrusion portion 36 protrudes in the open area on one side of the spool cover 30, the dial cam 60 is axially mounted on the shaft protrusion portion 36, and guide grooves extending in the forward-backward movement direction of the magnet holders 40 are formed in the partition of the spool cover 30.

The guide recesses include first guide recesses 37 to which protrusions 44 which are to be pressed of the magnet holders 40 approach and second guide recesses 38 to which guide protrusions 45 magnet holders 40 approach.

Here, the numbers and the arrangements of the guide protrusions 45 and the second guide recesses 38 may be varied. An embodiment in which the guide protrusions 45 are provided on both sides of the to-be-pressed protrusions 44 located at the center and the second guide recesses 38 are provided on both sides of the first guide recesses 37 located at the center can be seen from the figures.

Next, the magnet holders 40 slide in the open area on the other side in a direction perpendicular to the axial direction of the spool 10. The figures illustrate a shape in which two semicircular magnet holders 40 are coupled to each other while being opposed with respect to the shaft fitting portion 32 such that the magnets 41 are arranged in a circle like the facing portion 21, but the number of the magnet holders 40 may vary.

In each of the magnet holders 40, portions of the outer circumferential surface are open to form a radial arrangement of the mounting recesses 42 with the other ends (i.e., the inner ends) thereof being open. The magnets 41 are fitted and coupled to the mounting recesses 42, respectively. Here, the shape and the number of the magnets 41 are not limited.

Because a plurality of coin-shaped magnets 41 may be mounted on a single magnet holder 40, the number of the magnets 41 may be adjusted and set according to the user.

Arc plates 43 to which the magnetic force of the magnets 41 acts are mounted on the inner circumferential surfaces of the magnet holders 40, respectively.

The arc plates 43 prevent the magnets 41 from being separated by attraction with the magnets 41.

The arc plates 43 are formed of a metal material or implemented as magnets having different polarities from the magnets 41, and the magnets 41 are covered with the fixing plate 35 while being magnetically attracted toward the center of the magnet holders 40. In this manner, the magnets 41 are prevented from being separated or detached from the mounting recesses 42.

In addition, each of the magnet holders 40 includes the protrusions 44, which are to be pressed, and the guide protrusions 45 protruding from one side surface thereof.

The protrusions 44, which are to be pressed, have the shape of circular rods, and are fitted to pressing recesses 61 of the dial cam 60 through the first guide recesses 37. The guide protrusions 45 have a rectangular shape and are fitted to the second guide recesses 38 to guide forward and backward movements of the magnet holders 40.

In the dial cam 60, when rotated, the cam portions (i.e., the pressing recesses 61) press the protrusions 44, which are to be pressed, in a direction perpendicular to the axial direction of the spool 10, thereby moving the magnet holders 40 forwards and backwards.

The cam portions include the pressing grooves 61 each circumferentially formed in the other side surface of the dial cam 60 such that a corresponding one of the protrusions 44, which are to be pressed, is fitted thereto. The cam portion is configured to press the corresponding protrusion 44, which are to be pressed, with the distance thereof from the center of the dial cam 60 gradually increasing in the direction from one end to the other end thereof.

The control dial 70 is coupled to one side surface (i.e., the outer surface) of the dial cam 60 which is axially mounted while being received in the spool cover 30.

Each of the pressing grooves 61 extends in a shape similar to a spiral shape (e.g., a helical shape or a swirly shape) such that one end is formed at a position in the vicinity of the center of the dial cam 60 and the other end is formed at a position in the vicinity of the edge of the dial cam 60.

Because the protrusions 44, which are to be pressed, are fitted to the pressing grooves 61 through the linear first guide recesses 37, when the dial cam 60 rotates, the protrusions 44, which are to be pressed, move forwards and backwards radially in the pressing grooves 61 so that the positions of the magnet holders 40 are changed.

In addition, the dial cam 60 has a plurality of click recesses 62 formed inside the pressing grooves 61 to extend in the circumferential direction, and an elastic pin provided on the spool cover 30 is caught by one of the click recesses 62.

In addition, the control dial 70 coupled to the dial cam 60 is exposed externally through a rotation hole of the side cover 80.

An identifier 71 including symbols, numbers, or the like is provided on one side surface (i.e., an outer surface) of the control dial 70 to have the shape of a circle in order to indicate the position of rotation (e.g., the angle) of the control dial 70. An indicator is provided at one position in the circumferential direction of the rotation hole.

Accordingly, a user may adjust the position of the magnets 41 with respect to the facing portion 21, i.e., the distance between the facing portion 21 and the magnets 41, by adjusting the forward and backward positions of the magnet holders 40 by rotating the dial cam 60 using the control dial 70.

In a state in which basic braking force is set according to the user, when a fishing line is cast, the position of the variable brake 20 changes depending on the speed of rotation of the spool 10, and a corresponding braking force may be applied, thereby preventing backlash or a decrease in the flying distance in the casting.

Although the exemplary embodiments of the present disclosure have been described for illustrative purposes, those skilled in the art will appreciate that various modifications, additions, and substitutions are possible, without departing from the scope and spirit of the present disclosure as disclosed in the accompanying claims.

What is claimed is:

1. A fishing reel comprising:
a spool configured such that a shaft extends therethrough to be axially mounted on a reel body and a fishing line is wound thereon;
a variable brake comprising a facing portion provided in a circumferential direction of the spool, wherein the variable brake is coupled to one end of the shaft to be movable forwards and backwards in an axial direction of the spool and is elastically supported toward the spool;
magnet holders provided in a circumferential direction of the facing portion, coupled in a direction of an inner or outer circumferential surface of the facing portion to be movable forwards and backwards in a direction perpendicular to the axial direction of the spool, and comprising magnets mounted to form opposing surfaces with respect to the facing portion; and
a braking force control means for moving the magnet holders forwards and backwards.

2. The fishing reel of claim 1, wherein the braking force control means comprises:
a dial cam configured to rotate in the circumferential direction of the spool at one side of each of the magnet holders and comprising a cam portion configured to press and move the magnet holder forwards and backwards in a direction perpendicular to the axial direction of the spool; and
a control dial provided on a side cover to rotate the dial cam.

3. The fishing reel of claim 2, wherein each of the magnet holder comprises a protrusion protruding from one side surface thereof and configured to be pressed, and
the cam portion comprises a pressing groove circumferentially formed in the other side surface of the dial cam such that the protrusion configured to be pressed is fitted thereto, wherein the cam portion is configured to press the protrusion configured to be pressed, with a distance thereof from a center of the dial cam gradually increasing in a direction from one end to the other end thereof.

4. The fishing reel of claim 1, further comprising a spool cover comprising:
a receiving portion on one side of the magnet holders so as to receive the magnet holders; and
guide recesses configured to guide the holders in a direction perpendicular to the axial direction of the spool.
